(19) United States
(12) Patent Application Publication
(10) Pub. No.: US 2011/0113834 A1
(43) Pub. Date: May 19, 2011

(54) LOCK

(75) Inventors: Chih-Chen Lo, Taipei City (TW); Chih-Chin Yu, Taipei City (TW)

(73) Assignee: INVENTEC CORPORATION, Taipei City (TW)

(21) Appl. No.: 12/645,486

(22) Filed: Dec. 23, 2009

(30) Foreign Application Priority Data
Nov. 18, 2009 (TW) 98139211

(51) Int. Cl. E05B 73/00; E05B 65/00; E05B 15/08

(52) U.S. Cl. 70/58; 70/57

(57) ABSTRACT

A lock adapted for being assembled to an electronic device having a transmitting element is provided. The lock includes a first locking stand, a second locking stand, and a driving element. The first locking stand has a key inserting opening and a first rotating element located opposite to each other. The second locking stand disposed at a housing of the electronic device has an accommodating space and a second rotating element located opposite to each other, where the first locking stand is disposed in the accommodating space detachably. The second rotating element is assembled to the driving element, and the driving element is connected to the transmitting element. The first rotating element is forced to rotate when the first locking stand is disposed in the accommodating space, such that the second rotating element drives the driving element to rotate. Consequently, the driving element drives the transmitting element to move.

### CROSS-REFERENCE TO RELATED APPLICATION

This application claims the priority benefit of Taiwan application serial no. 98139211, filed Nov. 18, 2009. The entirety of the above-mentioned patent application is hereby incorporated by reference herein and made a part of specification.

### BACKGROUND OF THE INVENTION

1. Field of the Invention

The invention relates to a lock, and more particularly to a lock having a structure and functions different from those of a lock adopted in a conventional electronic device.

2. Description of Related Art

A docking of a portable computer allows a user to connect peripheral devices such as a mouse, a printer, or a network interface card with the docking constantly. Upon requirement, these peripheral devices can be used by simply connecting a connector of the portable computer to a connector of the docking. Accordingly, the portable computer is light-weighted and a connecting wire connected to the peripheral devices does not need to be plugged-in and removed repeatedly. On the other hand, in order to prevent the portable computer from being stolen when connected to the docking, a Kensington Lock is generally utilized to lock the docking at a fixed location, where the portable computer is locked on the docking at the same time.

### SUMMARY OF THE INVENTION

The invention relates to a lock, which has a structure and functions different from those of a lock adopted in a conventional electronic device.

The lock adapted for being assembled on an electronic device having a transmitting element is provided. The lock has a first locking stand, a second locking stand, and a driving element. The first locking stand has a key inserting opening and a first rotating element located opposite to each other. The second locking stand is disposed on a housing of the electronic device and has an accommodating space and a second rotating element located opposite to each other. Here, the first locking stand is disposed in the accommodating space detachably. The second rotating element of the second locking stand is assembled to the driving element, and the driving element is connected to the transmitting element of the electronic device. When the first locking stand is disposed in the accommodating space, the first rotating element of the first locking stand rotates and the second rotating element of the second locking stand driven by the first rotating element then drives the driving element to rotate, such that the driving element drives the transmitting element of the electronic device to move.

According to one embodiment of the lock in the invention, the first locking stand is a Kensington lock.

According to one embodiment of the lock in the invention, the second locking stand has a shaped of a saddle.

According to one embodiment of the lock in the invention, the transmitting element moves horizontally.

According to one embodiment of the lock in the invention, the driving element further includes a stopper, and the stopper stops the transmitting element when the driving element rotates to a locking position.

According to one embodiment of the lock in the invention, the lock further includes a key for inserting into the key inserting opening of the first locking stand. The key is turned so as to rotate the first rotating element.

In light of the foregoing, the structure of the lock in the invention is different from the structure of the conventional lock for locking the docking at a fixed position. The lock of the invention is adopted in the electronic device. Moreover, this lock not only drives the transmitting element in the electronic device to move, but the stopper of the driving element is also capable of stopping the transmitting element from returning. The lock of the invention provides functions that are different from those of the conventional lock, and thus has patentability.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic three-dimensional (3D) exploded view of a lock according to an embodiment of the invention.

FIG. 2 is a schematic 3D diagram of the lock in FIG. 1 being adopted in an electronic device.

FIG. 3 is a schematic diagram of the lock in an unlocked state.

FIG. 4 is a schematic diagram of the lock in a locked state.

### DESCRIPTION OF EMBODIMENTS

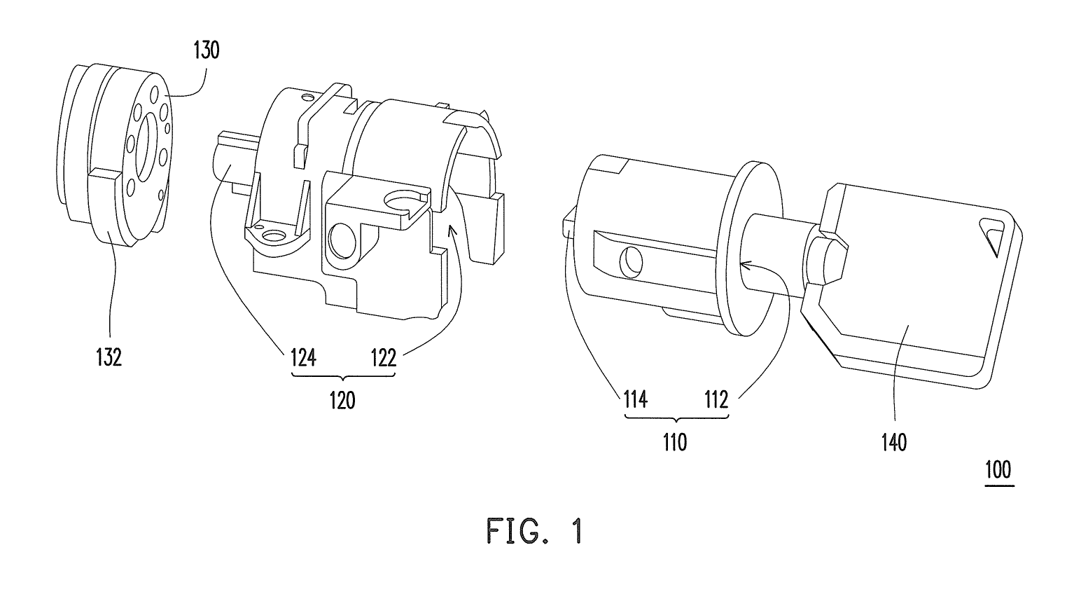

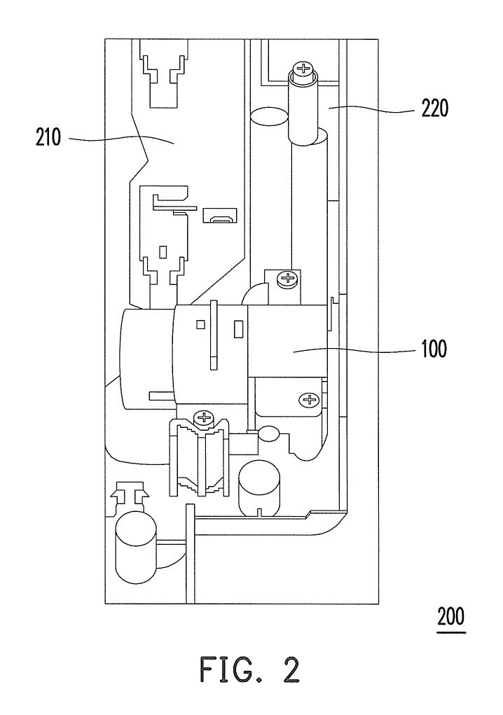

FIG. 1 is a schematic three-dimensional (3D) exploded view of a lock according to an embodiment of the invention. FIG. 2 is a schematic 3D diagram of the lock in FIG. 1 being adopted in an electronic device. Referring to FIG. 1 and FIG. 2 simultaneously, a lock 100 of the present embodiment is adapted for being assembled on an electronic device 200 having a transmitting element 210. The electronic device 200 is a docking of a notebook computer. The lock 100 includes a first locking stand 110, a second locking stand 120, and a driving element 130. The first locking stand 110 has a key inserting opening 112 and a first rotating element 114 located opposite to each other. The second locking stand 120 is assembled on a housing 220 of the electronic device 200. In addition, the second locking stand 120 has an accommodating space 122 and a second rotating element 124 located opposite to each other. Herein, the first locking stand 110 is disposed in the accommodating space 122 detachably. The second rotating element 124 of the second locking stand 120 is assembled to the driving element 130, and the driving element 130 is connected to the transmitting element 210 of the electronic device 200. When the first locking stand 110 is disposed in the accommodating space 122, the first rotating element 114 of the first locking stand 110 rotates and the second rotating element 124 of the second locking stand 120 driven by the first rotating element 114 then drives the driving element 130 to rotate, such that the driving element 130 drives the transmitting element 210 of the electronic device 200 to move. By adopting the lock 100 of the present embodiment, the transmitting element 210 of the electronic device 200 is driven to move, thereby stopping the transmitting element 210 from returning.

Referring to FIG. 1, the first locking stand 110 of the present embodiment is a Kensington lock which is not connected with a cable, and the second locking stand 120 has a shape of a saddle. Moreover, the lock 100 further includes a key 140 configured to be inserted into the key inserting opening 112 of the first locking stand 110. The key 140 is turned to rotate the first rotating element 114. The driving element 130 has a stopper 132. When the driving element 130 is rotated to a locking position, the stopper 132 stops the transmitting element 210. Generally, the saddle-shaped second locking stand 120 and the driving element 130 are normally assembled on the housing 220 of the electronic device 200. The first locking stand 110 is first disposed in the accommodating space 122, and the key 140 is then inserted into the key inserting opening 112; alternatively, depending on the demands, the key 140 can also be inserted into the key inserting opening 112 first, and the first locking stand 110 is then disposed in the accommodating space 122 of the second locking stand 120.

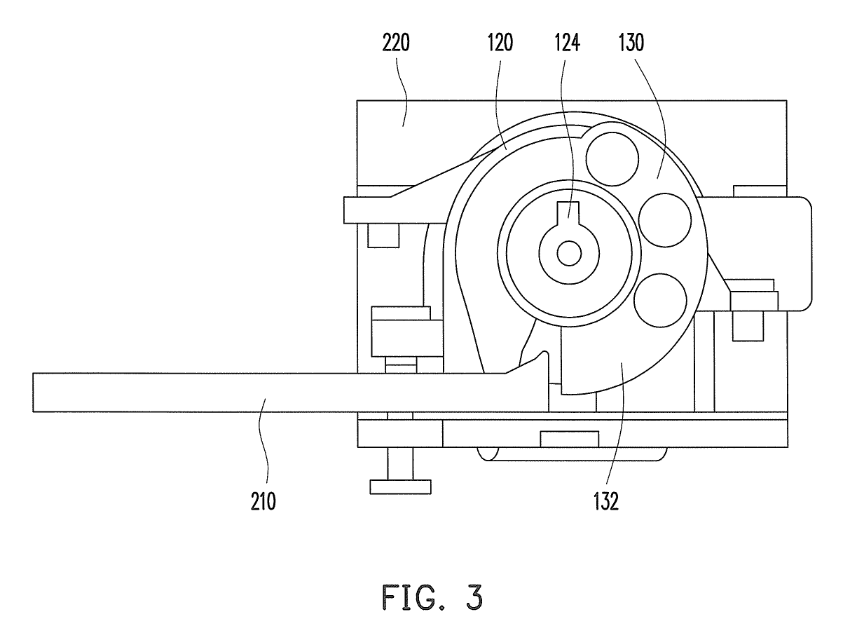

FIG. 3 is a schematic diagram of the lock in an unlocked state. Referring to FIGS. 1, 2, and 3 simultaneously, in a condition where the first locking stand 110 is normally disposed in the accommodating space 122 of the second locking stand 120, after a user inserts the key 140 into the key inserting opening 112 of the first locking stand 110 and before the key 140 is turned, the first rotating element 114 and the second rotating element 124 of the second locking stand 120 interfere with each other. The interference mentioned here means that the second rotating element 124 has a groove (not shown) which is complementary to a shape of the first rotating element 114 on a surface (not shown) toward the first locking stand 110. Moreover, the first rotating element 114 is inserted into the groove. Additionally, an interference between the driving element 130 and the second rotating element 124 is caused by disposing a groove (not shown) which is complementary to a shape of the second rotating element 124 on the driving element 130. The second rotating element 124 is inserted into the groove of the driving element 130. The methods of interference herein are merely presented for illustration. However, the invention is not limited thereto, persons of ordinary skills in the art can alter the embodiments depending on actual requirements and still be able of achieving the same purpose. At this time, the driving element 130 is in an unlocked state, and the stopper 132 and the transmitting element 210 do not contact each other. That is, the stopper 132 and the transmitting element 210 have a gap therebetween.

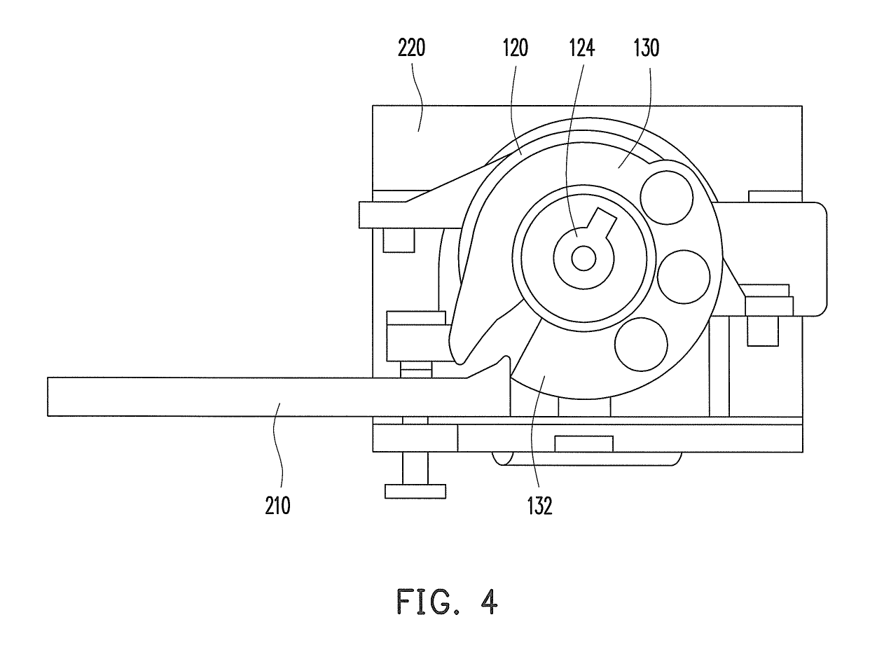

FIG. 4 is a schematic diagram of the lock in a locked state. Referring to FIGS. 1, 2, and 4, the key 140 is turned to rotate the first rotating element 114, and the second rotating element 124 is driven to rotate. Consequently, the second rotating element 124 drives the driving element 130 to rotate. The stopper 132 first contacts the transmitting element 210, and the user then turns the key 140 continuously, such that the driving element 130 also rotates continuously so as to be driven by the stopper 132. The transmitting element 210 moves horizontally on the housing 220, thereby driving other devices disposed inside the housing 220 to move. For example, a hard disk disposed in the docking is pushed out or other locks disposed on the housing 220 are locked.

Specifically, when the user rotates the key 140 continuously until the driving element 130 is driven on the locking position, the stopper 132 leans against the transmitting element 210, so that the transmitting element 210 cannot return to its original position. In other words, the driving element 130 not only drives the transmitting element 210 to move, but also restricts the transmitting element 210.

As aforementioned, when the restriction to the transmitting element 210 from the stopper 132 is to be removed for the stopper 132 to return to its original position, the user is required to open the lock with the key 140. As a consequence, the driving element 130 moves away from the locking position to release the restriction to the transmitting element 210.

Furthermore, a plurality of recesses and a plurality of protrusions corresponding thereto are suitably designed at junctions of at least two of the first locking stand 110, the second locking stand 120, and the driving element 130. The feeling of the user when turning the key 140 is enhanced with the cooperation of the recesses and the protrusions. The user then turns the key 140 in several segments to recognize the rotating angle more conveniently. To give an example, the rotation of the key 140 is divided into two segments, a rotation of the first segment includes rotating from 0° to 45° and a rotation of the second segment includes rotating from 45°to 90°.

Moreover, in the aforementioned embodiment, the driving of the transmitting element 210 by the driving element 130 to translate is illustrated as an example. However, persons of ordinary skills in the art can change the movement, such as the rotation or the unoriented sliding, of the transmitting element 210 depending on actual requirements.

In summary, the lock of the invention integrates the locking method of the conventional lock and cooperates with the driving element. Thus, the transmitting element is driven to enable the movements of other devices in the electronic device. Also, the disposition of the stopper of the driving element restricts the return of the transmitting element, and the user needs to use the key again to release the restriction between the driving element and the transmitting element. Compared to the conventional lock adopted in the electronic device, where the electronic device is locked in a fixed position, the structure, implemented technical features, and functions of the lock in the invention are all different from the conventional lock adopted in the electronic device. Hence, the lock of the invention has novelty, inventiveness, and utility.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A lock adapted for being assembled on an electronic device having a transmitting element, the lock comprising:
a first locking stand, having a key inserting opening and a first rotating element located opposite to each other;
a second locking stand, disposed at a housing of the electronic device and having an accommodating space and a second rotating element located opposite to each other, wherein the first locking stand is disposed in the accommodating space detachably; and
a driving element, having the second rotating element assembled thereto and connected to the transmitting element of the electronic device,
wherein when the first locking stand is disposed in the accommodating space, the first rotating element of the first locking stand rotates and the second rotating element of the second locking stand driven by the first rotating element then drives the driving element to rotate, such that the driving element drives the transmitting element of the electronic device to move.

2. The lock as claimed in claim 1, wherein the first locking stand is a Kensington lock.

3. The lock as claimed in claim 1, wherein the second locking stand has a shape of a saddle.

4. The lock as claimed in claim 1, wherein the transmitting element moves horizontally.

5. The lock as claimed in claim 1, wherein the driving element further comprises a stopper, and the stopper stops the transmitting element when the driving element rotates to a locking position.

6. The lock as claimed in claim 1, further comprising a key inserted into the key inserting opening of the first locking stand, wherein the key is turned so as to rotate the first rotating element.
